(19) United States
(12) Patent Application Publication
(10) Pub. No.: US 2014/0111731 A1
(43) Pub. Date: Apr. 24, 2014

(54) SLIM BEZEL LIQUID CRYSTAL DISPLAY DEVICE

(71) Applicant: Shenzhen China Sta Optoelecttronics Technolgy Co., Ltd., Shenzhen, Guangdong (CN)

(72) Inventors: Gang Yu, Shenzhen City (CN); Liuyang Yang, Shenzhen City (CN)

(73) Assignee: Shenzhen China Sta Optoelecttronics Technolgy Co., Ltd., Shenzhen, Guangdong (CN)

(21) Appl. No.: 13/805,652

(22) PCT Filed: Nov. 2, 2012
(86) PCT No.: PCT/CN12/83945

§ 371 Date: Dec. 19, 2012

(30) Foreign Application Priority Data
Oct. 18, 2012 (CN) 201210398084.X

(51) Int. Cl. G02F 1/1333

(52) U.S. Cl. CPC G02F 1/133308
USPC 349/58

(57) ABSTRACT

The present invention provides a slim bezel liquid crystal display device, which includes a rear enclosure, a front enclosure mating the rear enclosure, and a liquid crystal display module arranged inside the rear enclosure. The liquid crystal display module has a top forming first mounting holes and the rear enclosure has a top side board forming corresponding second mounting holes. Bolts are received through the second mounting holes and extend into the first mounting holes to fix the top of the liquid crystal display module in the rear enclosure. The rear enclosure includes a positioning strip arranged therein to correspond to a bottom of the liquid crystal display module for supporting the bottom of the liquid crystal display module thereby mounting the liquid crystal display module inside the rear enclosure.

### BACKGROUND OF THE INVENTION

1. Field of the Invention

The present invention relates to the field of liquid crystal displaying, and in particular to a slim bezel liquid crystal display device.

2. The Related Arts

Liquid crystal display (LCD) has numerous advantages, such as thin device body, less power consumption, and being free of radiation, and is thus widely used. Most of the liquid crystal display devices that are available in the market are backlighting liquid crystal displays, which comprise a liquid crystal display panel and a backlight module. The operation principle of the liquid crystal display panel is that liquid crystal molecules are arranged between two parallel glass substrates and electricity is selectively applied to the glass substrates to cause change of the orientation of the liquid crystal molecules in order to refract out the light from a backlight module for formation of an image.

A conventional liquid crystal display device generally comprises a rear enclosure, a front enclosure that mates the rear enclosure and a liquid crystal display module arranged in the rear enclosure. The liquid crystal display module is often fixed inside the rear enclosure by being screwed from the front side to the rear side. And then, the front enclosure is fit to the rear enclosure. Referring to FIG. 1, a schematic view is given to show an assembling structure of a conventional liquid crystal display module, which comprises an outer frame 100 forming bolt mounting zones 300. The bolt mounting zones 300 form bolt holes 500 and bolts are received through the bolt holes 500 to fix the liquid crystal display module in the rear enclosure. Due to the arrangement of the bolt mounting zones 300, the front enclosure needs a wide bezel to cover the bolt mounting zones 300. Consequently, a non-display zone of the liquid crystal display device is thus expanded. Further, since the manner of fixing is done by screwing from the front side to the rear side, the thickness of the liquid crystal display device is thus increased. With the constant progress of the manufacturing techniques of liquid crystal display device, the trend of development of liquid crystal display device is now toward bezel slimming and device thinning. The manner of fixing the liquid crystal display module to the rear enclosure affects the bezel width and overall thickness of the liquid crystal display device to quite an extent.

### SUMMARY OF THE INVENTION

An object of the present invention is to provide a slim bezel liquid crystal display device, which has a simple structure, is easy to maintain, can effectively realize bezel slimming and device thinning of the liquid crystal display device, and is capable of effectively controlling maintenance cost.

To achieve the object, the present invention provides a slim bezel liquid crystal display device, which comprises a rear enclosure, a front enclosure mating the rear enclosure, and a liquid crystal display module arranged in the rear enclosure. The liquid crystal display module has a top forming first mounting holes and the rear enclosure has a top side board forming corresponding second mounting holes. Bolts are received through the second mounting holes and extend into the first mounting holes to fix the top of the liquid crystal display module in the rear enclosure. The rear enclosure comprises a positioning strip arranged therein to correspond to a bottom of the liquid crystal display module for supporting the bottom of the liquid crystal display module thereby mounting the liquid crystal display module inside the rear enclosure.

The liquid crystal display module comprises a back frame and a liquid crystal display panel received in the back frame.

The back frame comprises a base board and a first side board connected to the base board.

The first mounting holes are formed in the first side board of the back frame.

The rear enclosure comprises a bottom board and a second side board formed on the bottom board.

The positioning strip is an elongate parallelepiped.

The positioning strip is set perpendicular to the bottom board.

The positioning strip is integrally formed with the bottom board.

The first mounting holes are threaded holes and the second mounting holes are through holes, whereby bolts are received through the second mounting holes to engage in the first mounting holes so as to mount the liquid crystal display module in the rear enclosure.

The first mounting holes are blind holes and the second mounting holes are through holes, whereby the bolts are screwed in the second mounting holes and further extended into the first mounting holes so as to mount the liquid crystal display module in the rear enclosure.

The present invention also provides a slim bezel liquid crystal display device, which comprises a rear enclosure, a front enclosure mating the rear enclosure, and a liquid crystal display module arranged in the rear enclosure, the liquid crystal display module having a top forming first mounting holes, the rear enclosure having a top side board forming corresponding second mounting holes, bolts being received through the second mounting holes and extending into the first mounting holes to fix the top of the liquid crystal display module in the rear enclosure, the rear enclosure comprising a positioning strip arranged therein to correspond to a bottom of the liquid crystal display module for supporting the bottom of the liquid crystal display module thereby mounting the liquid crystal display module inside the rear enclosure;

wherein the liquid crystal display module comprises a back frame and a liquid crystal display panel received in the back frame;

wherein the back frame comprises a base board and a first side board connected to the base board;

wherein the first mounting holes are formed in the first side board of the back frame;

wherein the rear enclosure comprises a bottom board and a second side board formed on the bottom board;

wherein the positioning strip is an elongate parallelepiped;

wherein the positioning strip is set perpendicular to the bottom board;

wherein the positioning strip is integrally formed with the bottom board;

wherein the first mounting holes are threaded holes and the second mounting holes are through holes, whereby bolts are received through the second mounting holes to engage in the first mounting holes so as to mount the liquid crystal display module in the rear enclosure; and

wherein the first mounting holes are blind holes and the second mounting holes are through holes, whereby the bolts are screwed in the second mounting holes and further extended into the first mounting holes so as to mount the liquid crystal display module in the rear enclosure.

The efficacy of the present invention is that the present invention provides a slim bezel liquid crystal display device, which comprises a positioning strip mounted in a rear enclosure to correspond to a bottom of a liquid crystal display module for supporting the weight of the liquid crystal display module and uses bolts to fix a top of the liquid crystal display module so as to mount the liquid crystal display module in the rear enclosure. The structure is simple and the assembling operation is easy so as to effectively achieve bezel slimming and device thinning of a liquid crystal display device. Further, easy disassembling can be done with the liquid crystal display module in case of maintenance and replacement so that the maintenance cost can be effectively controlled.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic view showing an assembling structure of a conventional liquid crystal display module; and

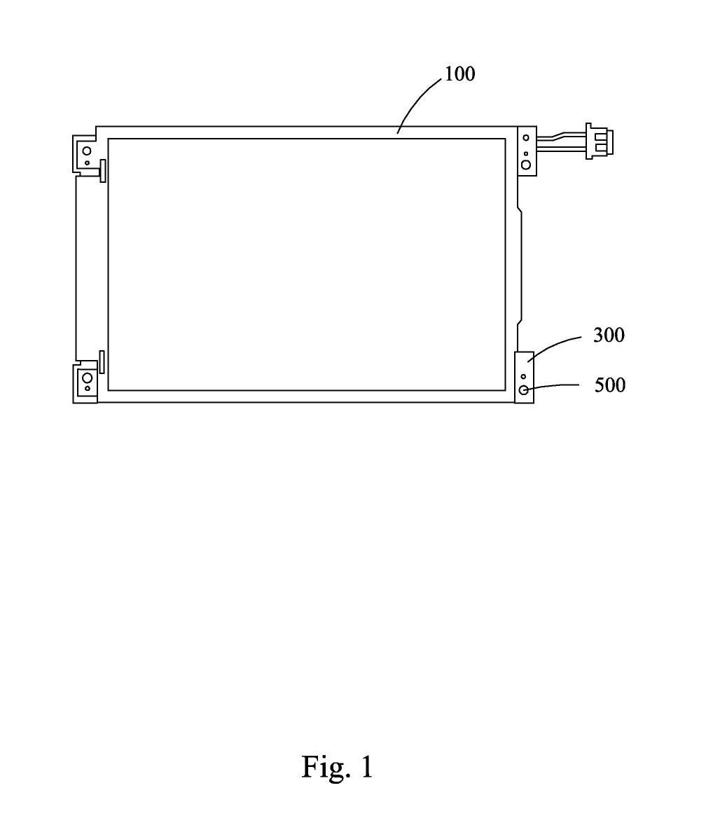

FIG. 2 is an exploded view showing a slim bezel liquid crystal display device according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

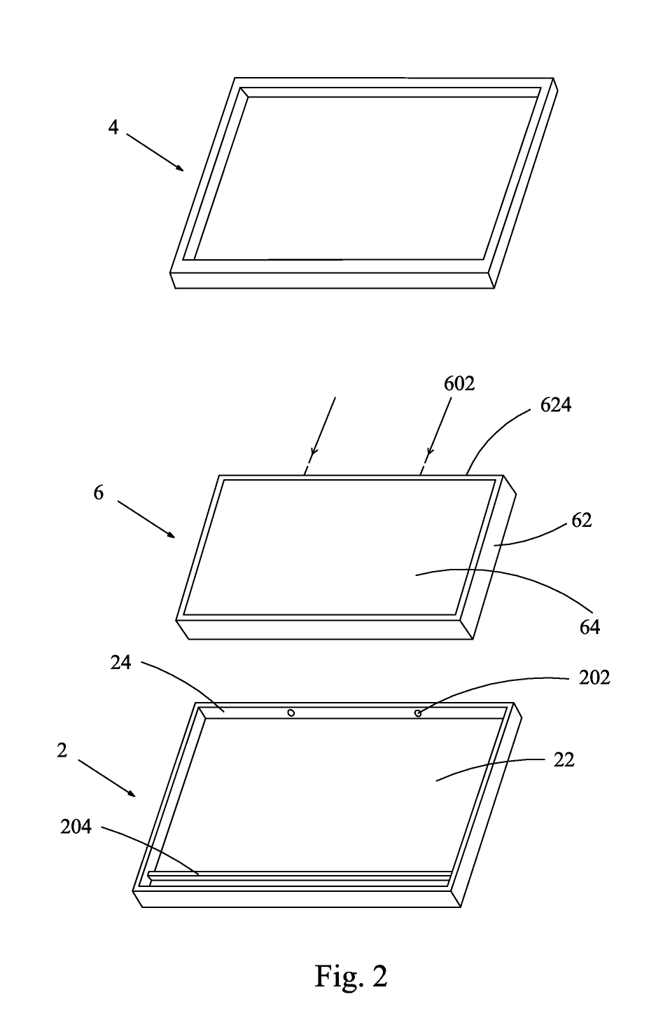

Referring to FIG. 2, the present invention provides a slim bezel liquid crystal display device, which comprises a rear enclosure 2, a front enclosure 4 mating the rear enclosure 2, and a liquid crystal display module 6 arranged inside the rear enclosure 2. The liquid crystal display module 6 has a top forming first mounting holes 602 and the rear enclosure 2 has a top side board 24 forming corresponding second mounting holes 202. Bolts (not shown) are received through the second mounting holes 202 and extend into the first mounting holes 602 to fix the top of the liquid crystal display module 6 in the rear enclosure 2. The rear enclosure 2 comprises a positioning strip 204 arranged therein to correspond to a bottom of the liquid crystal display module 6 for supporting the bottom of the liquid crystal display module 6 thereby mounting the liquid crystal display module 6 inside the rear enclosure 2.

The liquid crystal display module 6 comprises a back frame 62 and a liquid crystal display panel 64 received in the back frame 62. The back frame 62 comprises a base board (not shown) and a first side board 624 connected to the base board. The first mounting holes 602 are formed in the first side board 624 of the back frame 62. The rear enclosure 2 comprises a bottom board 22 and a second side board 24 connected to the bottom board. The positioning strip 204 is an elongate parallelepiped. The positioning strip 204 is set perpendicular to the bottom board 22. The positioning strip 204 is integrally formed with the bottom board 22. To assemble, the positioning strip 204 of the rear enclosure 2 supports the weight of the liquid crystal display module 6. The top of the liquid crystal display module 6 is fixed inside the rear enclosure 2 by bolts so as to mount the liquid crystal display module 6 inside the rear enclosure 2. The front enclosure 4 is then set on the rear enclosure 2 to complete the assembling of the liquid crystal display device.

The first and second mounting holes 602, 202 are of numbers determined according to practical needs. In the instant embodiment, the first mounting holes 602 are two and the second mounting holes 202 are correspondingly two.

The liquid crystal display module 6 further comprises a backlight module (not shown) arranged inside the back frame 62. The backlight module provides a uniformly distributed planar light source to the liquid crystal display panel 64 to ensure normal operation of the liquid crystal display module 6.

The first mounting holes 602 can be threaded holes or blind holes. The second mounting holes 202 can be correspondingly through holes or threaded holes. When the first mounting holes 602 are threaded holes, the second mounting holes 202 are correspondingly through holes, whereby the bolts are received through the second mounting holes 202 to engage inside the first mounting holes 602 so as to mount the liquid crystal display module 6 in the rear enclosure 2. When the first mounting holes 602 are blind holes, the second mounting holes 202 are correspondingly threaded holes, whereby the bolts are screwed in the second mounting holes 202 and further extended into the first mounting holes 602 so as to mount the liquid crystal display module 6 in the rear enclosure 2.

In summary, the present invention provides a slim bezel liquid crystal display device that comprises a positioning strip mounted in a rear enclosure to correspond to a bottom of a liquid crystal display module for supporting the weight of the liquid crystal display module and uses bolts to fix a top of the liquid crystal display module so as to mount the liquid crystal display module in the rear enclosure. The structure is simple and the assembling operation is easy so as to effectively achieve bezel slimming and device thinning of a liquid crystal display device. Further, easy disassembling can be done with the liquid crystal display module in case of maintenance and replacement so that the maintenance cost can be effectively controlled.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A slim bezel liquid crystal display device, comprising a rear enclosure, a front enclosure mating the rear enclosure, and a liquid crystal display module arranged in the rear enclosure, the liquid crystal display module having a top forming first mounting holes, the rear enclosure having a top side board forming corresponding second mounting holes, bolts being received through the second mounting holes and extending into the first mounting holes to fix the top of the liquid crystal display module in the rear enclosure, the rear enclosure comprising a positioning strip arranged therein to correspond to a bottom of the liquid crystal display module for supporting the bottom of the liquid crystal display module thereby mounting the liquid crystal display module inside the rear enclosure.

2. The slim bezel liquid crystal display device as claimed in claim 1, wherein the liquid crystal display module comprises a back frame and a liquid crystal display panel received in the back frame.

3. The slim bezel liquid crystal display device as claimed in claim 1, wherein the back frame comprises a base board and a first side board connected to the base board.

4. The slim bezel liquid crystal display device as claimed in claim 3, wherein the first mounting holes are formed in the first side board of the back frame.

5. The slim bezel liquid crystal display device as claimed in claim 1, wherein the rear enclosure comprises a bottom board and a second side board formed on the bottom board.

6. The slim bezel liquid crystal display device as claimed in claim 1, wherein the positioning strip is an elongate parallelepiped.

7. The slim bezel liquid crystal display device as claimed in claim 6, wherein the positioning strip is set perpendicular to the bottom board.

8. The slim bezel liquid crystal display device as claimed in claim 1, wherein the positioning strip is integrally formed with the bottom board.

9. The slim bezel liquid crystal display device as claimed in claim 1, wherein the first mounting holes are threaded holes and the second mounting holes are through holes, whereby bolts are received through the second mounting holes to engage in the first mounting holes so as to mount the liquid crystal display module in the rear enclosure.

10. The slim bezel liquid crystal display device as claimed in claim 1, wherein the first mounting holes are blind holes and the second mounting holes are through holes, whereby the bolts are screwed in the second mounting holes and further extended into the first mounting holes so as to mount the liquid crystal display module in the rear enclosure.

11. A slim bezel liquid crystal display device, comprising a rear enclosure, a front enclosure mating the rear enclosure, and a liquid crystal display module arranged in the rear enclosure, the liquid crystal display module having a top forming first mounting holes, the rear enclosure having a top side board forming corresponding second mounting holes, bolts being received through the second mounting holes and extending into the first mounting holes to fix the top of the liquid crystal display module in the rear enclosure, the rear enclosure comprising a positioning strip arranged therein to correspond to a bottom of the liquid crystal display module for supporting the bottom of the liquid crystal display module thereby mounting the liquid crystal display module inside the rear enclosure;
wherein the liquid crystal display module comprises a back frame and a liquid crystal display panel received in the back frame;
wherein the back frame comprises a base board and a first side board connected to the base board;
wherein the first mounting holes are formed in the first side board of the back frame;
wherein the rear enclosure comprises a bottom board and a second side board formed on the bottom board;
wherein the positioning strip is an elongate parallelepiped;
wherein the positioning strip is set perpendicular to the bottom board;
wherein the positioning strip is integrally formed with the bottom board;
wherein the first mounting holes are threaded holes and the second mounting holes are through holes, whereby bolts are received through the second mounting holes to engage in the first mounting holes so as to mount the liquid crystal display module in the rear enclosure; and
wherein the first mounting holes are blind holes and the second mounting holes are through holes, whereby the bolts are screwed in the second mounting holes and further extended into the first mounting holes so as to mount the liquid crystal display module in the rear enclosure.
